(19) United States
(12) Patent Application Publication
(10) Pub. No.: US 2025/0374316 A1
(43) Pub. Date: Dec. 4, 2025

(54) METHODS AND SYSTEMS FOR BAND STEERING

(71) Applicant: Comcast Cable Communications, LLC, Philadelphia, PA (US)

(72) Inventors: Rong Chen, Sunnyvale, CA (US); Allen Huotari, Sunnyvale, CA (US); David Urban, Sunnyvale, CA (US)

(21) Appl. No.: 18/680,842

(22) Filed: May 31, 2024

(51) Int. Cl. H04W 72/542; H04B 17/336; H04W 72/02; H04W 72/04; H04W 84/12

(52) U.S. Cl. CPC H04W 72/542; H04W 72/02; H04W 72/04; H04B 17/336; H04W 84/12

(57) ABSTRACT

Methods, apparatuses, and systems are described for determining whether a user device connected to a network via a first communication channel in a first band of a network device should connect to a second communication channel in a second band of the network device. The network device may determine a trigger event based on a characteristic of the first communication channel. Based on the trigger event, the network device may compare one or more characteristics of the first communication channel with one or more thresholds to determine whether the user device should connect to the second communication channel in the second band.

### BACKGROUND

User devices connect to wireless access points, or wireless gateway devices, via one of many access channels in different bands. However, a single channel of the wireless access point may become congested due to many user devices using the channel to connect to the wireless access point. Band steering is a method used to optimize channel utilization in a given wireless access point to avoid congestion and overloading one band over another band by enabling multi-band wireless user devices to connect to a less crowded band, such as a 5 GHz band, leaving another band, such as a 2.4 GHz band, available to other user devices that may only support the other band. Conventional band steering methods rely on a triggering mechanism for post-association band steering. This trigger mechanism is typically based on watermark crossing. However, first, the watermark crossing involves a single-occurrence trigger that reflects the Wi-Fi condition at a single time instant. Second, to prevent down steering and up steering oscillation, a considerable gap between low and high watermarks is required. In addition, all watermark crossing events are treated equally, without a quantitative differentiation among them. Lastly, conventional band steering mechanisms are based on the assumption that when the SNR value in one band increases or decreases, the SNR value in another band also increases or decreases. This assumption does not take into account differences in interferences in different bands, different noise values in different bands, and varying SNR values between bands due to non-line-of-sight and/or other environmental conditions impacting radio wave propagation.

### SUMMARY

It is to be understood that both the following general description and the following detailed description are exemplary and explanatory only and are not restrictive. Methods, systems, and apparatuses systems for an improved triggering mechanism for post-association band steering are described.

A user device may implement a post-association band steering process associated with switching the user device between network bands (e.g., 2.4 GHz, 5 GHZ, 6 GHZ, etc.), including switching the user device between network channels, after an initial association of the user device to a current band. The post-association band steering process may be implemented based on a series of cross-checks of signal-to-noise ratio (SNR) data in the current band and other target bands. The cross-checks may be performed as multiple-time spanning events. The user device may initially connect to a network via a first communication channel in a first band of a network device. The network device may determine whether the user device should connect to the network via another channel, such as a second communication channel in a second band of the network device based on a satisfying a condition, such as when a value of the SNR data of the first communication channel falls below, or rises above, a particular value, level, or a threshold. Based on satisfying the condition, the network device may compare one or more characteristics of the first communication channel with one or more thresholds to determine whether the user device should connect to the second communication channel in the second band. The network device may then perform a cross-check of SNR data of the second communication channel in the second band before performing an action with respect to the user device. If the user device is configured for basic service set transition management (BTM) steering, the network device may send a steering request indicating that the user device should connect to the network via the second communication channel in the second band. If the user device is not configured for BTM steering, the network device may perform a forced de-authentication/dis-association action on the user device, forcing the user device to disconnect from and then re-connect to the network, with an improved likelihood to switch to the second communication channel in the second band.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system for creating and maintaining data indicative of one or more devices connected to a network;

FIG. 2 shows an example scenario of the user device moving away or towards an access point;

FIGS. 3A-3B shows example measurements associated with a band steering scenario;

FIGS. 4A-4B shows example measurements associated with a band steering scenario;

FIGS. 5A-5B shows example measurements associated with a band steering scenario;

FIGS. 6A-6B shows example measurements associated with a band steering scenario;

FIGS. 7A-7B shows example measurements associated with a band steering scenario;

FIGS. 8A-8B shows example measurements associated with a band steering scenario;

FIGS. 9A-9B shows example measurements associated with a band steering scenario;

FIGS. 10A-10B shows example measurements associated with a band steering scenario;

FIG. 11 shows a flowchart of an example method;

FIG. 12 shows a flowchart of an example method;

FIG. 13 shows a flowchart of an example method; and

FIG. 14 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

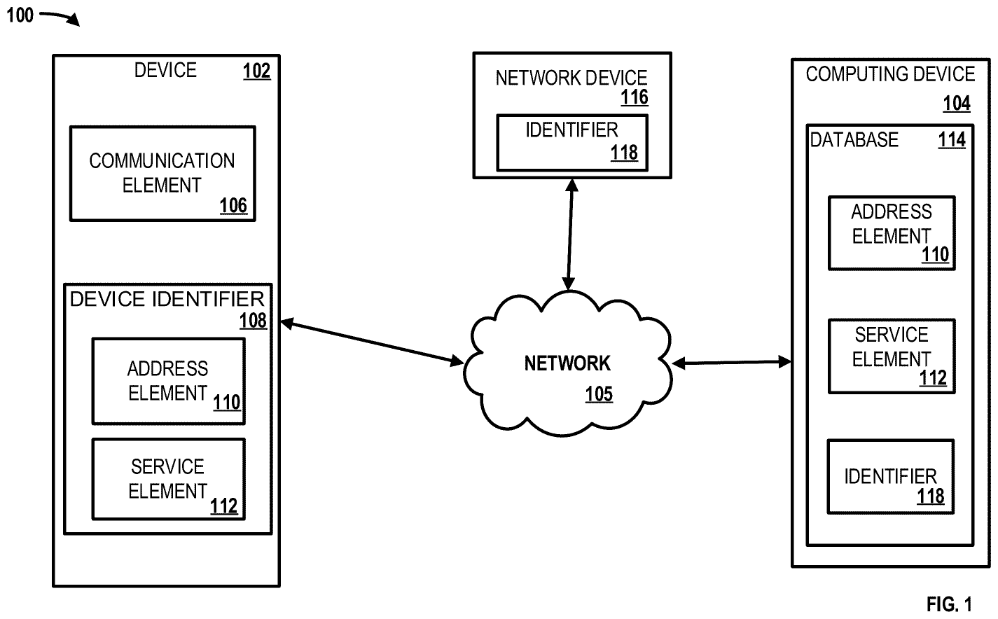

FIG. 1 shows an example system 100 for performing post-association band steering of a device (e.g., a device 102, a computing device 104, and/or a network device 116). For example, the system 100 may be configured to determine whether a user device (e.g., device 102) connected to a network (e.g., network 105) via a first communication channel in a first band (e.g., 2.4 GHz, 5 GHZ, 6 GHZ, etc.) of a wireless access point (e.g., network device 116) should connect to the network via a second communication channel in a second band of the wireless access point. In an example, the system 100 may be configured to determine whether the user device should switch between communication channels regardless of the network band. For example, the wireless access point may be configured to determine that signal-to-noise ratio (SNR) data of the first communication channel satisfies a condition (e.g., a value of the SNR data of the first communication channel falls below, or rises above, a watermark threshold). Based on satisfying the condition, the wireless access point may determine one or more characteristics of the first communication channel at each time point of a series of time points. At each time point, the wireless access point may compare the one or more characteristics of the first communication channel with one or more thresholds to determine whether the user device should connect to the second communication channel in the second band. Further, the wireless access point may perform a cross-check of SNR data of the second communication channel at each time point and compare it with one or more thresholds before causing the user device to connect to the second communication channel in the second band. For example, if the user device is configured for BTM steering, the wireless access point may send a steering request to the user device, wherein the user device may determine whether it will switch to the second communication channel in the second band, or if the device is not configured for BTM steering, the wireless access point may perform a forced de-authentication/dis-association action on the user device, forcing the user device to disconnect from and then re-connect to the network, with an improved likelihood that the user device connects to the second communication channel in the second band. The system 100 may be configured to provide services, such as network-related services, to a device. The network and system may comprise a device 102 in communication with a computing device 104, such as a server, via a network 105 via a network device 116. The computing device 104 may be disposed locally or remotely relative to the device 102. As an example, the device 102 and the computing device 104 may be in communication via a private and/or public network 105 such as the Internet or a local area network (LAN) via the network device 116. Other forms of communications can be used such as wired and wireless telecommunication channels, for example.

The device 102 may comprise a user device such as a computer, a smartphone, a laptop, a tablet, a set top box, a display device, other device capable of communicating with the network device 116 and/or the computing device 104, and the like. The user device may comprise customer premises equipment that may be configured to enable the user to connect to an OTT service. For example, the customer premises equipment may comprise devices such as Internet of Things (IoT) devices, VoIP devices, routers, printers, Wi-Fi speakers, security cameras, smart assistant devices, and the like.

As an example, the device 102 may comprise a communication element 106 for providing an interface to a user to interact with the device 102 and/or the computing device 104. The communication element 106 can be any interface for presenting and/or receiving information to/from the user, such as user feedback. For example, an interface may comprise a communication interface such as a web browser (e.g., Internet Explorer®, Mozilla Firefox®, Google Chrome®, Safari®, or the like). Other software, hardware, and/or interfaces may be used to provide communication between the user and one or more of the device 102 and the computing device 104. As an example, the communication element 106 may request or query various files from a local source and/or a remote source. As an example, the communication element 106 may transmit data to a local or remote device such as the computing device 104.

The device 102 may be associated with a user identifier or a device identifier 108. For example, the device identifier 108 may be any identifier, token, character, string, or the like, for differentiating one user or user device (e.g., device 102) from another user or user device. In an example, the device identifier 108 may identify a user or user device as belonging to a particular class of users or user devices. In an example, the device identifier 108 may comprise information relating to the device 102 such as a manufacturer, a model or type of device, a service provider associated with the device 102, a state of the device 102, a locator, and/or a label or classifier. Other information can be represented by the device identifier 108.

The device identifier 108 may comprise an address element 110 and a service element 112. The address element 110 may comprise or provide an Internet protocol address, a network address, a media access control (MAC) address, international mobile equipment identity (IMEI) number, international portable equipment identity (IPEI) number, or the like. As an example, the address element 110 can be relied upon to establish a communication session between the device 102 and the computing device 104 or other devices and/or networks. As an example, the address element 110 can be used as an identifier or locator of the device 102. As an example, the address element 110 can be persistent for a particular network.

The service element 112 may comprise an identification of a service provider associated with the device 102, with the class of device 102, and/or with a particular network 105 with which the device 102 is currently accessing services provided by, or associated with, the service provider. The class of the device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the device 102. As an example, the service element 112 may comprise information relating to a preferred service provider for one or more particular services relating to the device 102. In an example, the address element 110 can be used to identify or retrieve data from the service element 112, or vice versa. As an example, one or more of the address element 110 and the service element 112 may be stored remotely from the device 102 and retrieved by one or more devices such as the device 102 and the computing device 104. Other information may be represented by the service element 112.

The device 102 may be configured to connect to a network (e.g., network 105), such as the Internet, via a wireless access point, or gateway device, (e.g., network device 116). For example, the device 102 may access network 105 (e.g., the Internet) via a first communication channel of the network device 116. For example, the network device 116 may provide a plurality of communication channels in different bands (e.g., 2.4 GHz, 5 GHZ, 6 GHz, etc.) for which a device may use to connect to the network 105 via the network device 116. The device 102 may initially connect to the network 105 via the first communication channel in a first band of the network device 116. The network device 116 may determine whether the device 102 should connect to the network 105 via a second communication channel in a second band and either send a steering request to the device 102 or perform a forced de-authentication/dis-association action on the device 102. For example, if the device 102 is configured for BTM steering, the network device 116 may send the steering request to the device 102, wherein the device 102 may determine whether to connect to the network 105 via the second communication channel in the second band based on the steering request. For example, if the device 102 is not configured for BTM steering, the network device 116 may perform the forced de-authentication/dis-association action on the device 102, forcing the device 102 to disconnect from and then re-connect to the network, with an improved likelihood to switch to the second communication channel. The network device 116 may determine whether the device 102 is capable of BTM steering when the device 102 initially requests to connect to the network device 116, wherein the device 102 may send an indication of the device's 102 capability to support BTM.

The network device 116 may determine that the SNR data of the first communication channel satisfies a condition (e.g., a value of the SNR data of the first communication channel falls below, or rises above, a watermark threshold), triggering the network device 116 to perform one or more calculations at each time point of a series of time points to determine whether the device 102 should switch to the second communication channel. In an example, the device 102 may move in a direction away from the network device 116. As the device 102 moves away from the network device 116, a value of the SNR data of the first communication channel may fall below a first threshold (e.g., low watermark SNR value/threshold) and the network device 116 may determine that the device 102 may need to down-steer to the second communication channel in the second band (e.g., the device should “down steer” from the 5G band to the 2G band). In an example, the device 102 may move in a direction towards the network device 116. As the device 102 moves towards the network device 116, a value of the SNR data may rise above a second threshold (e.g., high watermark SNR value/threshold) and the network device 116 may determine that the device 102 may need to up-steer to the second communication channel (e.g., the device should “up steer” from the 2G band to the 5G band).

Based on satisfying the condition, the network device 116 may determine that one or more characteristics of the first communication channel at one or more time points of the series of time points satisfies a third threshold. The one or more characteristics may comprise one or more of a SNR delta, a value associated with the SNR delta, a value associated with a previous SNR delta, or a value associated with a changing rate of SNR delta. For example, the third threshold may comprise a predetermined low threshold (e.g., low watermark threshold) and/or predetermined high threshold (e.g., high watermark threshold). The one or more characteristics may comprise one or more of a difference/delta between the SNR of the first communication channel and one of the low or high thresholds (e.g., low watermark SNR value/threshold or high watermark SNR value/threshold) at a time point, a proportional factor associated with the current SNR difference/delta, an integral factor associated with an impact of an accumulation of past SNR differences/deltas, and a derivative factor associated with an impact of a change rate of SNR differences/deltas. As an example, the one or more characteristics may comprise an absolute value of a sum of the difference/delta between the SNR of the first communication channel and one of the low or high thresholds at the time point, the proportional factor, the integral factor, and the derivative factor. In an example, the one or more characteristics may comprise one or more of the difference/delta between the SNR of the first communication channel and one of the low or high threshold at a time point, the proportional factor, the integral factor, and the derivative factor based on a type of device connected to the network device 116. For example, for stationary devices (e.g., IoT devices, Wi-Fi speakers, security cameras, smart assistant devices, etc.), the integral factor may be deemphasized since the SNR differences/deltas would be insignificant due to the devices staying in one location relative to the network device 116.

Based on the one or more characteristics at the one or more time points satisfying the third threshold, the network device 116 may determine that the device 102 should connect to the network 105 via the second communication channel in the second band. In an example, if the device 102 is configured for BTM steering, based on the one or more characteristics at the one or more time points exceeding the third threshold but not exceeding a fourth threshold, the network device 116 may send the steering request and an indication that disassociation from the first communication channel is not imminent (e.g., loss of connection via the first communication channel is not imminent). In an example, if the device 102 is configured for BTM steering, based on the one or more characteristics at the one or more time points exceeding the fourth threshold, the network device 116 may send the steering request and an indication that disassociation from the first communication channel is imminent (e.g., loss of connection via the first communication channel is imminent). The device 102 may determine whether it will accept the steering request and connect to the network 105 via the second communication channel in the second band, or ignore/reject the steering request and remain connected to the network 105 via the first communication channel in the first band. In an example, if the device 102 is not configured for BTM steering, based on the one or more characteristics at the one or more time points exceeding the third threshold but not exceeding the fourth threshold, the network device 116 may perform the forced de-authentication/dis-association action on the device 102 after the device 102 becomes idle. In an example, if the device 102 is not configured for BTM steering, based on the one or more characteristics exceeding the fourth threshold, the network device 116 may perform the forced de-authentication/dis-association action on the device 102 without waiting for the device 102 to become idle. As an example, the device 102 may be considered to be idle if no data frames are being exchanged between the device 102 and the network device 116 for a period of time (e.g., 2 minutes, 5 minutes, 15 minutes, etc.) or if it is in a power-saving mode. If the network device 116 applies a forced de-authentication/dis-association action to the device 102, then the device 102 has no choice but to accept the de-authentication/dis-association action, disconnect from and then re-connect to the network, with an improved likelihood, to switch to the second communication channel in the second band.

The network device 116 may be configured to assign a Service Set Identifier (SSID) for each band for the user devices (e.g., device 102) to use to connect to the network (e.g., network 105). For example, the first band may be assigned a first SSID and the second band may be assigned a second SSID. The device 102 may connect to the first communication channel in the first band via the first SSID and connect to the second communication channel in the second band via the second SSID. Each band and corresponding SSID may correspond to a wireless local area network. For example, the first band and corresponding first SSID may be associated with a first wireless local area network and the second band and corresponding second SSID may be associated with a second wireless local area network.

The network device 116 may determine that the one or more characteristics of the first communication channel at each time point of the series of time points does not satisfy the third threshold. Based on the one or more characteristics at each time point not satisfying the third threshold, the network device 116 may determine (e.g., generate a steering decision) that the device 102 should remain connected to the network 105 via the first communication channel in the first band. Based on the determination, the network device 116 may either refrain from sending the steering request if the device 102 is configured for BTM steering or refrain from performing the forced de-authentication/dis-association action to the device 102 if the device 102 is not configured for BTM steering.

Further, before the network device 116 sends the steering request or performs the forced de-authentication/dis-association action, the network device 116 may perform a series of cross-checks (e.g., according to the series of time points) of SNR data of the second communication channel. If the SNR data of the second communication channel satisfies a second condition (e.g., the SNR data does not suggest steering from the second communication channel back to the first communication channel and/or the SNR data corresponds to a higher data rate in the second communication channel than in the first communication channel), then the network device 116 may send the steering request to, or perform the de-authentication/dis-association action on, the device 102. For example, before the network device 116 issues an up steering request from a 2G communication channel to a 5G communication channel, the network device 116 may cross-check (e.g., at each time point) and ensure that a value of the current 5G SNR data is higher than a low watermark SNR value and/or a value of the current 5G SNR data corresponds to a higher data rate in 5G than that in 2G in order to prevent an immediate down steer from 5G to 2G. If the second condition is not met, then the network device 116 may stop, without issuing the up-steering request or performing the forced de-authentication/dis-association action.

In an example, the network device 116 may either always output a steering decision based on the one or more characteristics determined at a first time point of the series of time points, output a steering decision for each time point the one or more characteristics are determined, or only output a steering decision based on the one or more characteristics determined at a last time point of the series of time points. If the network device 116 is configured to always output the steering decision based on the one or more characteristics determined at the first time point, for the subsequent time points the one or more characteristics are determined, the network device 116 may output a steering decision only if the decision is as demanding as or even more demanding than the previous steering decision. For example, if the one or more characteristics determined at a previous time point caused a non-imminent BTM steering request to be generated and the one or more characteristics determined at the present time point cause an imminent BTM steering request to be generated, the network device 116 may output the new steering decision.

The computing device 104 may comprise a server for communicating with the device 102 and/or the network device 116. As an example, the computing device 104 may communicate with the device 102 for providing data and/or services. As an example, the computing device 104 may provide services, such as network (e.g., Internet) connectivity, network printing, media management (e.g., media server), content services, streaming services, broadband services, or other network-related services. As an example, the computing device 104 may allow the device 102 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the device 102 and a database 114 for sending and receiving data therebetween. As an example, the database 114 may store a plurality of files (e.g., video files, audio files, image files, etc.), user identifiers or records, or other information. As an example, the device 102 may request and/or retrieve a file from the database 114. As an example, the database 114 may store information relating to the device 102 such as the address element 110 and/or the service element 112. As an example, the computing device 104 may obtain the device identifier 108 from the device 102 and retrieve information from the database 114 such as the address element 110 and/or the service elements 112. As an example, the computing device 104 may obtain the address element 110 from the device 102 and may retrieve the service element 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

The network device 116 may be in communication with a network, such as the network 105. For example, the network device 116 may facilitate the connection of a device, such as device 102, to the network 105. As an example, the network device 116 may be configured as a gateway device or wireless access point (WAP). In an example, the network device 116 may be configured to allow one or more wireless devices (e.g., device 102) to connect to a wired and/or wireless network using Wi-Fi, Bluetooth®, Zigbee®, or any desired method or standard.

The network device 116 may comprise an identifier 118. As an example, one or more identifiers may be or relate to an Internet Protocol (IP) Address (e.g., IPV4/IPV6) or a media access control address (MAC address) or the like. As an example, the identifiers 118 may be a unique identifier for facilitating communications on the physical network segment. In an example, the network device 116 may comprise a distinct identifier 118. As an example, the identifier 118 may be associated with a physical location of the network device 116.

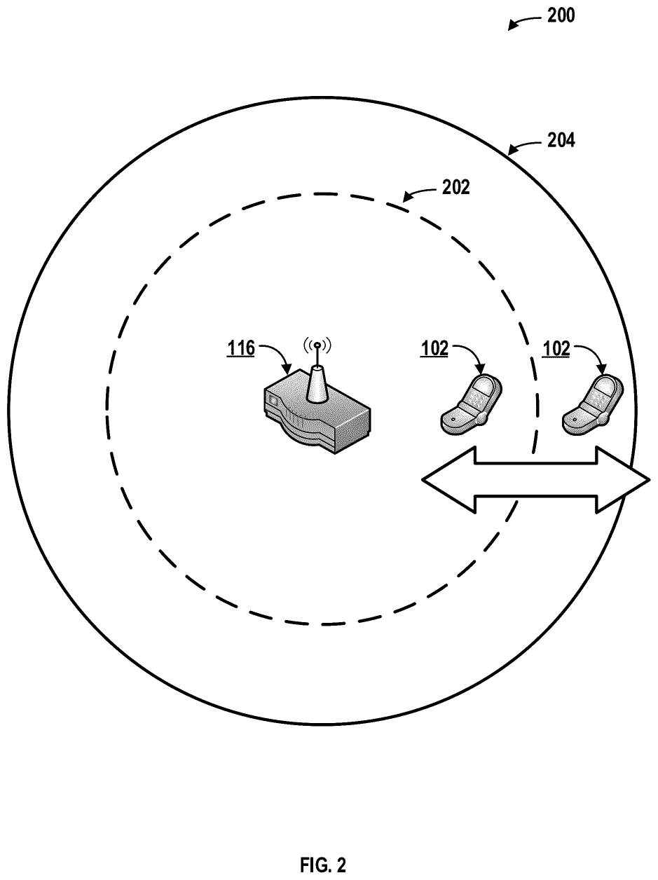

FIG. 2 shows an example scenario 200 wherein the device 102 moves in a direction away or towards the network device 116. The network device 116 may be configured to provide a plurality of communication channels in different bands (e.g., 2.4 GHz, 5 GHZ, 6 GHz band, etc.) for which devices (e.g., device 102) may access in order to connect to the network (e.g., network 105), such as the internet, via the network device 116. For example, the network device 116 may be configured to assign a SSID for each band, wherein the devices may connect to each band via each SSID. As shown in FIG. 2, the network device 116 may provide a first communication channel 202 in a first band (e.g., in 5 GHz or 5G band associated with a first SSID) and a second communication channel 204 in a second band (e.g., in 2.4 GHz or 2G band associated with a second SSID). The device 102 may initially connect to a network via the first communication channel 202 of the network device 116. The network device 116 may determine whether the device 102 should connect to the network via the second communication channel 204 and send a steering request to, or perform a de-authentication/dis-association action on, the device 102 based on the determination. For example, the network device 116 may determine that signal-to-noise ratio (SNR) data of the first communication channel 202 satisfies a condition. As an example, the network device 116 may determine that the device 102 should “down steer” from the 5G band to the 2G band if a value of the SNR data falls from above a first threshold (e.g., low watermark SNR value/threshold) to below the first threshold. For example, as the device 102 moves in a direction away from the network device 116, a value of the SNR data may fall below the first threshold. As an example, the network device 116 may determine that the device 102 should “up steer” from the 2G band to the 5G band if a value of the SNR data rises from below a second threshold (e.g., high watermark SNR value/threshold) to above the second threshold. For example, as the device 102 moves in a direction towards the network device 116, a value of the SNR data may rise above the second threshold.

Based on satisfying the condition, the network device 116 may perform a plurality of calculations associated with a configurable time window t, or sampling time. For example, t=0 may represent the first sampling time when the condition is satisfied. As an example, SNR (t) may represent a current SNR reading and SNR (t−1) may represent a last SNR reading. The network device 116 may calculate O(t)=|P(t)+I(t)+D(t)|. P(t) may comprise a proportional factor for capturing the impact of the current SNR difference/delta d(t), wherein P(t)=kₚ*d(t), wherein d(t)=0 for t<0. d(t) may comprise a delta/difference between SNR and watermark values at time t. For example, d(t)=lwm−SNR(t) for down steering or d(t)=SNR(t)−hwm for up steering. I(t) may comprise an integral factor for capturing the impact of the accumulation of past SNR deltas/differences, wherein I(t)=kᵢ*I(t−1)+d(t−1), wherein I(t)=0 for t<1. D(t) may comprise a derivative factor for capturing the impact of a changing rate of SNR deltas/differences, wherein D(t)=k_{d}*{[d(t)−d(t−1)]−[d(t−1)−d(t−2)]}, wherein D(t)=0 for t<2. In an example, if d(t) becomes negative, the calculations of P(t), I(t), and D(t) may stop. In an example, kₚ, kᵢ, and k_{d} may comprise predetermined values.

The network device 116 may determine that one or more characteristics (e.g., O(t)=|P(t)+I(t)+D(t)|) associated with the first communication channel 202 satisfy a third threshold. The third threshold may comprise a predetermined low threshold (e.g., low watermark threshold) or predetermined high threshold (e.g., high watermark threshold). For example, the one or more characteristics may comprise one or more of the difference/delta, d(t), between the SNR of the first communication channel 202 and one of the low or high thresholds (e.g., low watermark SNR value/threshold or high watermark SNR value/threshold) at a time point, the proportional factor, P(t), associated with the current SNR difference/delta, the integral factor, I(t), associated with an impact of an accumulation of past SNR differences/deltas, and the derivative factor, D(t), associated with an impact of a change rate of SNR differences/deltas. For example, the one or more characteristics may comprise a value associated with, or comprising, O(t)=|P(t)+I(t)+D(t)|. In an example, O(t) may be calculated based on one or more of P(t), I(t), and/or D(t) based on a type of device connected to the network device 116. For example, for stationary devices (e.g., Internet of Things (IoT) devices, Wi-Fi speakers, security cameras, smart assistant devices, etc.), the integral factor may be deemphasized since the SNR differences/deltas would be insignificant due to the devices staying in one location relative to the network device 116. The network device 116 may determine whether the device 102 should connect to the second communication channel 204 of the network device 116 based on determining that the one or more characteristics of the first communication channel 202 satisfy the third threshold and send a steering request to, or perform a de-authentication/dis-association action on, the device 102 based on the determination.

As an example, if the device 102 is configured for BTM steering, the network device 116 may one or more of: refrain from sending a steering request to the device 102 if O(t)<threshold_low (e.g. low threshold); send a steering request that the device 102 should switch, but that disassociation is not imminent, to the second communication channel 204 if threshold_low<O(t)<threshold_high (e.g., high threshold); or send a steering request that the device 102 should switch, and that disassociation is imminent, to the second communication channel 204 if threshold_high<O(t). If the device 102 is not configured for BTM steering, the network device 116 may one or more of: perform no action so that the device 102 may remain connected to the network via the first communication channel 202 if O(t)<threshold_low; de-authenticate/dis-associate the device 102 from the first communication channel 202 to force the device 102 to disconnect from and then re-connect to the network, with an improved likelihood to switch to the second communication channel 204, once the device 102 becomes idle if threshold_low<O(t)<threshold_high; or de-authenticate/dis-associate the device 102 from the first communication channel 202 to force the device 102 to disconnect from and then re-connect to the network, with an improved likelihood to switch to the second communication channel 204, without waiting for the device 102 to become idle if threshold_high<O(t).

As an example, when the network device 116 makes a determination that the device 102 should switch to the second communication channel 204 (e.g., by sending a steering request or performing a de-authentication/dis-association action), the network device 116 may first perform a cross-check of the SNR data in the second/target communication channel 204. For example, the network device 116 may further determine that the SNR data of the second communication channel 204 satisfies a fourth threshold (e.g., the SNR data does not suggest steering from the second communication channel 204 back to the first communication channel 202 and/or the SNR data corresponds to a higher data rate in the second communication channel 204 than in the first communication channel 202). For example, when the determined one or more characteristics associated with the first communication channel 202 indicate that the device 102 should switch to the second communication channel 204 (e.g., an up steering trigger event from 2G to 5G), if a value of the current 5G SNR data is higher than the low watermark SNR value, or if a value of the current 5G SNR data corresponds to a higher data rate in 5G than that in 2G, the network device 116 may determine that the device 102 should switch to the second communication channel 204 and either send the steering request to, or perform the de-authentication/dis-association action on, the device 102.

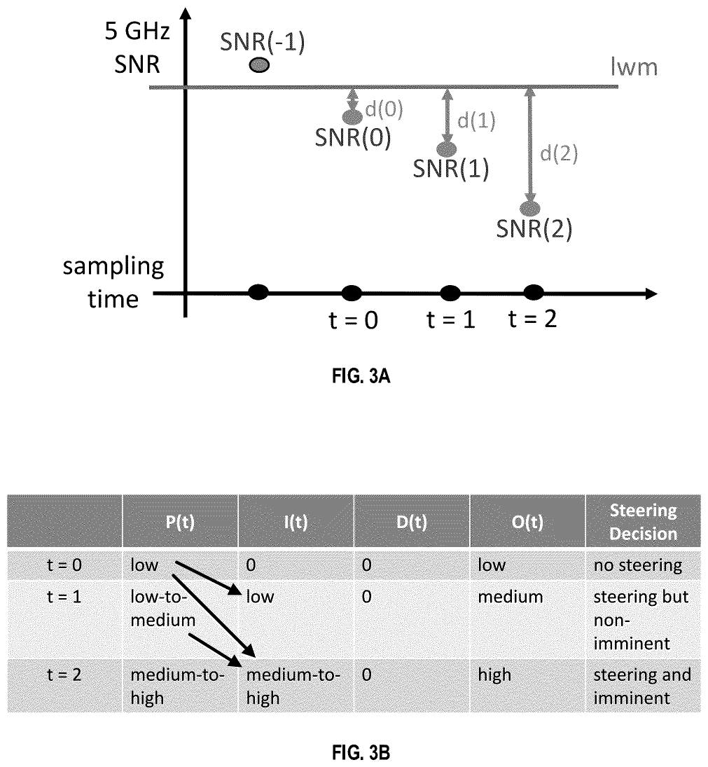

As an example, a person holding device 102 may walk away from the network device 116. A shown in FIG. 3A, as a person holding device 102 walks at a constant speed away from the network device 116, a value of the 5G SNR data may drop below the low watermark along the way. As shown in FIG. 3B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 should switch, but disassociation is not imminent, to the second communication channel 204 based on a medium O(t) value, wherein P(t) comprises a low-to-medium value, I(t) comprises a low value, and D(t)=0. At t=2, the network device 116 may determine that the device 102 should switch, and disassociation is imminent, to the second communication channel 204 based on a high O(t) value, wherein P(t) comprises a medium-to-high value, I(t) comprises a medium-to-high value, and D(t)=0.

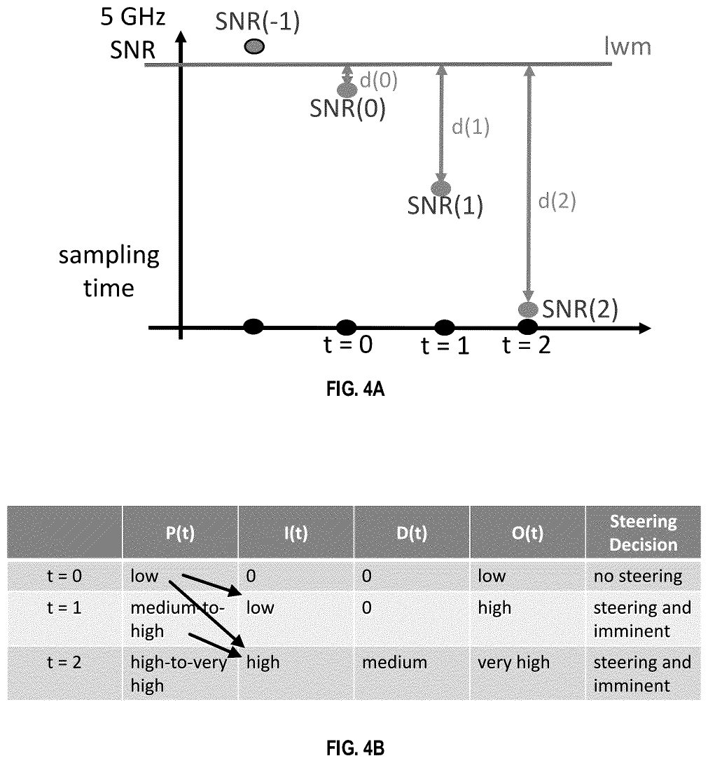

As shown in FIG. 4A, as a person holding device 102 walks at an accelerated pace away from network device 116, a value of the 5G SNR data may drop increasingly faster below the low watermark along the way. In this case, imminent steering may occur sooner than as shown in FIGS. 3A-3B. As shown in FIG. 4B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 should switch, and disassociation is imminent, to the second communication channel 204 based on a high O(t) value, wherein P(t) comprises a medium-to-high value, I(t) comprises a low value, and D(t)=0. At t=2, the network device 116 may determine that the device 102 should switch, and disassociation is imminent, to the second communication channel 204 based on a very high O(t) value, wherein P(t) comprises a high-to-very high value, I(t) comprises a high value, and D(t) comprises a medium value.

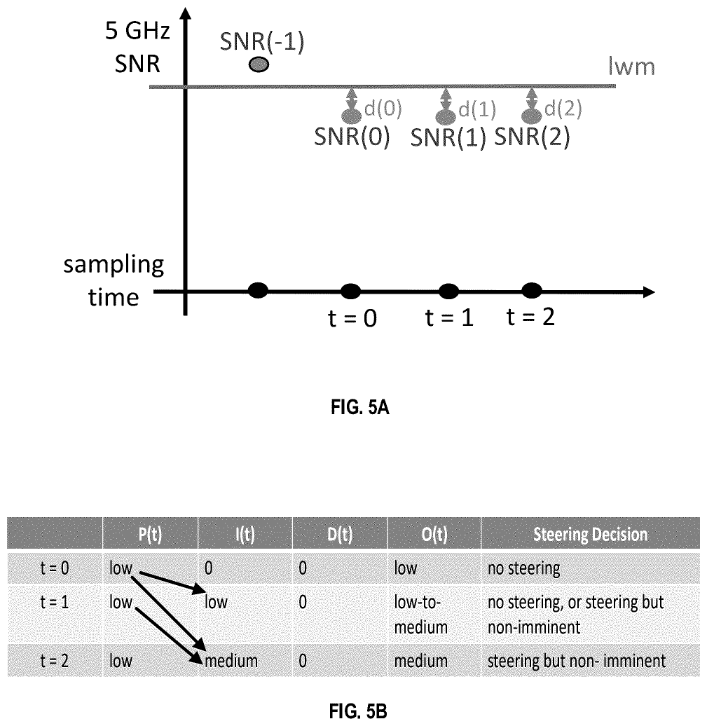

As shown in FIG. 5A, as a person holding device 102 walks at a constant speed away from the network device 116, a value of the 5G SNR data may drop below the low watermark along the way. However, the person holding the device 102 may stop after a value of the 5G SNR data crosses the low watermark, wherein a value of the 5G SNR data may stop dropping, or remain the same, after crossing the low watermark. As shown in FIG. 5B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 may either remain connected to the network via the first communication channel 202 or switch, but disassociation is not imminent, to the second communication channel 204 based on a low-to-medium O(t) value, wherein P(t) comprises a low value, I(t) comprises a low value, and D(t)=0. At t=2, the network device 116 may determine that the device 102 should switch, but disassociation is not imminent, to the second communication channel 204 based on a medium O(t) value, wherein P(t) comprises a low value, I(t) comprises a medium value, and D(t)=0.

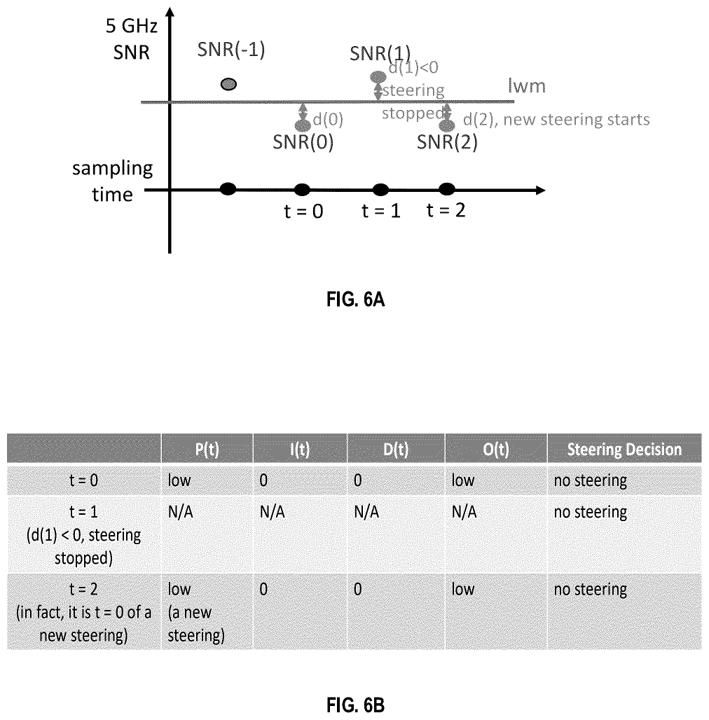

As shown in FIG. 6A, as a person holding device 102 walks at a constant speed away from the network device 116, a value of the 5G SNR data may drop below the low watermark along the way. However, the person holding the device 102 may walk back and forth after the 5G crosses the low watermark, wherein a value of the 5G SNR data may rise above and fall below the low watermark as the person walks back and forth. As shown in FIG. 6B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 may remain connected to the network via the first communication channel 202, wherein the O(t), P(t), I(t), and D(t) values are not applicable. For example, d(1)<0 causing the steering to stop because the device 102 is not dwelling below the low watermark. At t=2, the network device 116 may determine that the device 102 may remain connected to the network via the first communication channel 202 based on a low O(t) value, wherein P(t) comprises a low value, I(t)=0, and D(t)=0. For example, t=2 is essentially the start of a new steering decision (e.g., t=0).

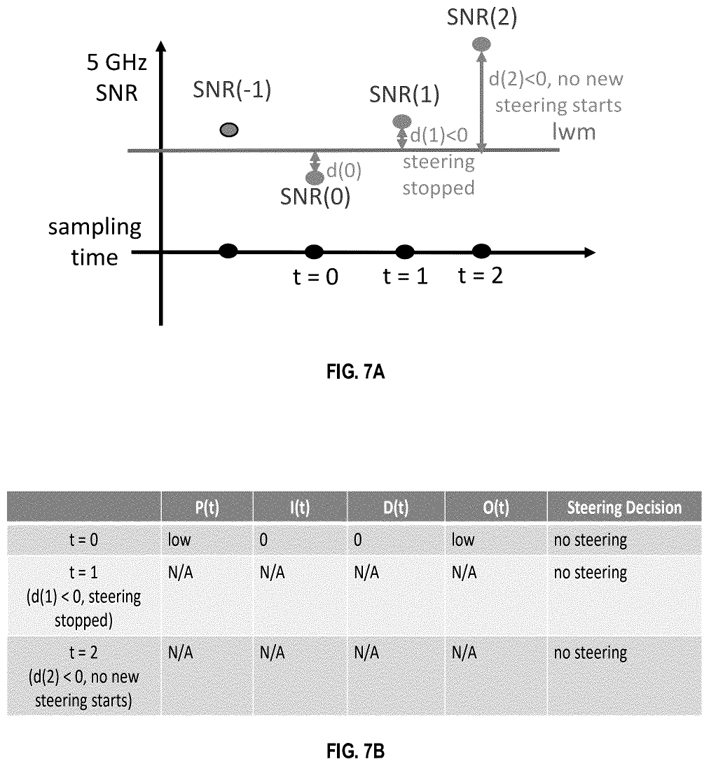

As shown in FIG. 7A, as a person holding the device 102 walks at a constant speed away from the network device 116, a value of the 5G SNR data may drop below the low watermark along the way. However, the person holding the device 102 may walk back towards the network device 116, causing a value of the 5G SNR data to rise above the low watermark. As shown in FIG. 7B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 may remain connected to the network via the first communication channel 202, wherein the O(t), P(t), I(t), and D(t) values are not applicable. For example, d(1)<0 causing the steering to stop because the device 102 is not dwelling below the low watermark. At t=2, the network device 116 may determine that the device 102 may remain connected to the network via the first communication channel 202, wherein the O(t), P(t), I(t), and D(t) values are not applicable. For example, d(2)<0 and new steering does not start (e.g., steering does not resume).

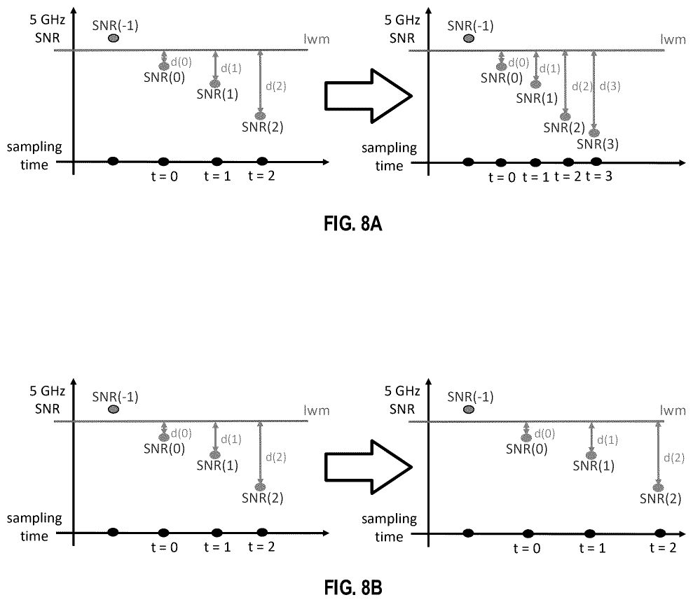

The sampling interval t may comprise a plurality of sampling intervals (e.g., configurable sampling intervals). For example, by setting different sampling intervals t, different scenarios (e.g., burst noise, fast fading, etc.) may be more easily accommodated. As shown in FIGS. 8A-8B, as a person holding the device 102 walks away from the network device 116, a value of the 5G SNR data may drop below the low watermark along the way. As an example, based on a decreased sampling interval t, the number of samples determined by the network device 116 may increase, as shown in FIG. 8A. As an example, based on an increased sampling interval t, the time it takes for the network device 116 to determine a sample may increase, as shown in FIG. 8B.

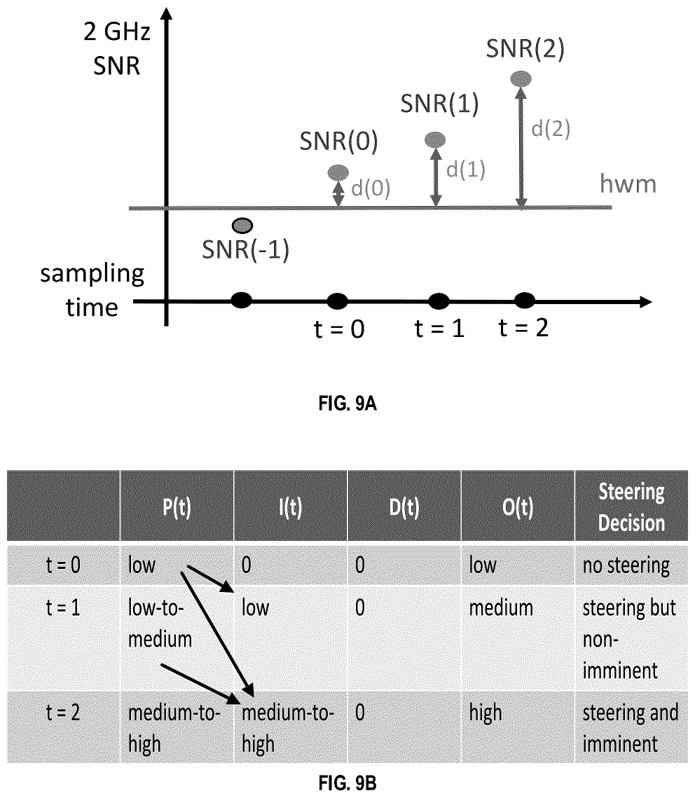

As an example, a person holding device 102 may walk towards the network device 116. As shown in FIG. 9A, as a person holding device 102 walks at a constant speed towards the network device 116, a value of the 2G SNR data may rise above the high watermark along the way. As shown in FIG. 9B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 should switch, but disassociation is not imminent, to the second communication channel 204 based on a medium O(t) value, wherein P(t) comprises a low-to-medium value, I(t) comprises a low value, and D(t)=0. At t=2, the network device 116 may determine that the device 102 should switch, and disassociation is imminent, to the second communication channel 204 based on a high O(t) value, wherein P(t) comprises a medium-to-high value, I(t) comprises a medium-to-high value, and D(t)=0.

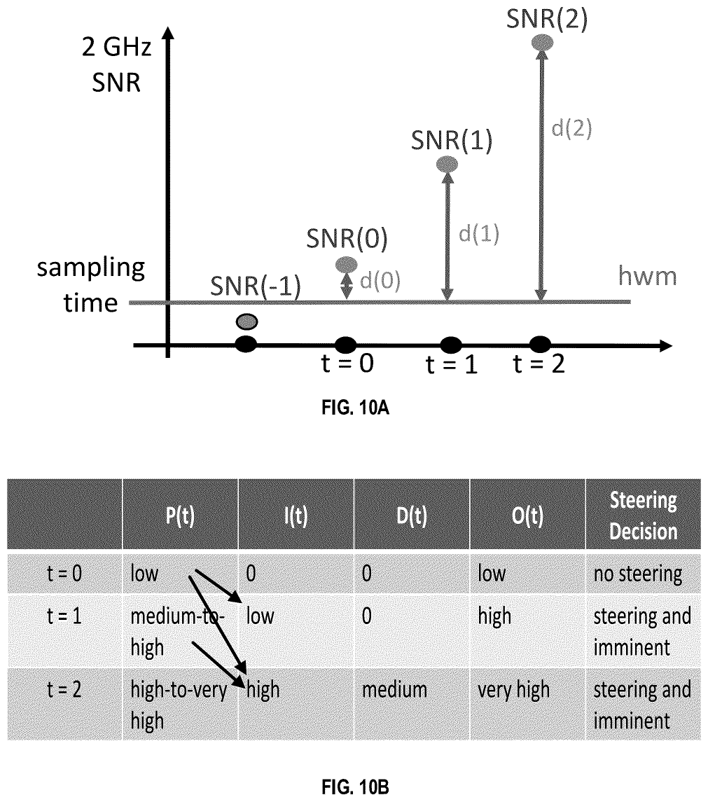

As shown in FIG. 10A, as a person holding device 102 walks at an accelerated pace towards the network device 116, a value of the 2G SNR data may rise increasingly faster above the high watermark along the way. In this case, imminent steering may occur sooner than as shown in FIGS. 9A-9B. As shown in FIG. 10B, at t=0, the network device 116 may determine that the device 102 may remain connected to the network via the first communication channel 202 based on a low O(t) value, wherein P(t) comprises a low value, I(t)=0, and D(t)=0. At t=1, the network device 116 may determine that the device 102 should switch, and disassociation is imminent, to the second communication channel 204 based on a high O(t) value, wherein P(t) comprises a medium-to-high value, I(t) comprises a low value, and D(t)=0. At t=2, the network device 116 may determine that the device 102 should switch, and disassociation is imminent, to the second communication channel 204 based on a very high O(t) value, wherein P(t) comprises a high-to-very high value, I(t) comprises a high value, and D(t) comprises a medium value.

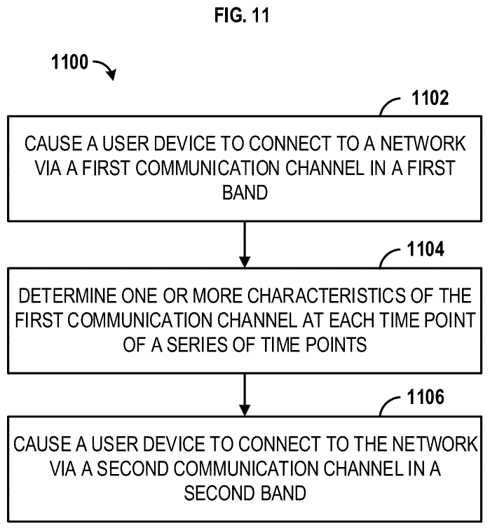

FIG. 11 shows a flow chart of an example method 1100 for performing post-association band steering of a device. For example, an access point, or gateway device, may be configured to provide a plurality of communication channels in different bands (e.g., 2.4 GHz, 5 GHZ, 6 GHZ, etc.) for which devices may access in order to connect to a network. The access point, or gateway device, may provide an up steering or a down steering request to the device for the device to switch from a first communication channel in a first band to a second communication channel in a second band. Method 1100 may be implemented by a computing device (e.g., network device 116, computing device 104, access point, gateway device, etc.). At step 1102, a user device may connect to a network via a first communication channel in a first band. For example, the computing device (e.g., network device 116, computing device 104, etc.) may cause the user device to connect to the network via a first communication device of the computing device. As an example, a Service Set Identifier (SSID) may be assigned to each band, wherein the user device may connect to the network via the SSID. For example, the first band may be assigned a first SSID and a second band may be assigned a second SSID. The user device may connect to the first communication channel in the first band via the first SSID and connect to a second communication channel in the second band via the second SSID. Each band and corresponding SSID may correspond to a wireless local area network. For example, the first band and corresponding first SSID may be associated with a first wireless local area network and the second band and corresponding second SSID may be associated with a second wireless local area network. The network may comprise the Internet.

At step 1104, based on signal-to-noise ratio (SNR) data of the first communication channel satisfying a first condition, one or more characteristics of the first communication channel at each time point of a series of time points may be determined based on a series of values of the SNR data according to the series of time points. For example, based on the SNR data of the first communication channel satisfying the first condition, the computing device (e.g., network device 116, computing device 104, etc.) may determine the one or more characteristics of the first communication channel at each time point of the series of time points based on the series of values of the SNR data according to the series of time points. For example, based on the SNR data crossing a threshold (e.g., first condition), the computing device may be triggered to implement a series of cross checks of the SNR data of the first communication channel in the first band and a second communication channel in a second band. The computing device may determine one or more characteristics of each communication channel at each time point after the trigger. The one or more characteristics may comprise one or more of a SNR delta, a value associated with the SNR delta, a value associated with a previous SNR delta, or a value associated with a changing rate of SNR delta. The first condition may comprise one of a value of the SNR data falling below a first threshold, or a value of the SNR data rising above a second threshold. For example, a value of the SNR data of the first communication channel may fall below a low watermark SNR threshold, or a value of the SNR data may rise above a high watermark SNR threshold. For example, as the user device moves away from the computing device, a value of the SNR data of the first communication channel may fall below the first threshold (e.g., low watermark SNR threshold) and the computing device may determine that the user device may need to down-steer to the second communication channel in the second band (e.g., the user device should “down steer” from the 5G band to the 2G band). For example, as the user device moves towards the computing device, a value of the SNR data may rise above the second threshold (e.g., high watermark SNR threshold) and the computing device may determine that the user device may need to up-steer to the second communication channel (e.g., the device should “up steer” from the 2G band to the 5G band).

At step 1106, based on the one or more characteristics at one or more time points of the series of time points satisfying a third threshold, the user device may connect to the network via the second communication channel in the second band. For example, based on the one or more characteristics at the one or more time points satisfying the third threshold, the computing device (e.g., network device 116, computing device 104, etc.) may cause the user device to connect to the network via the second communication channel in the second band. For example, the computing device may send a steering request to the user device, wherein the user device may connect to the network via the second communication channel in the second band based on the steering request. For example, the computing device cause the user device to disconnect from the network via the first communication channel in the first band, wherein the user device may connect to the network via the second communication channel in the second band based on being disconnected from the network via the first communication channel in the first band.

As an example, the computing device may either always output a steering decision (e.g., cause the user device to connect to the network via the second communication channel in the second band) based on the one or more characteristics at a first time point of the series of time points satisfying the third threshold, output a steering decision for each time point the one or more characteristics satisfy the third threshold, or only output a steering decision based on the one or more characteristics at a least time point of the series of time points satisfying the third threshold. If the computing device is configured to always output the steering decision based on the one or more characteristics at the first time point satisfying the third threshold, the computing device may only output the steering decision for the one or more characteristics at subsequent time points if the steering decision is as demanding as or even more demanding than the previous one. For example, if the one or more characteristics determined at the previous time point caused a non-imminent BTM steering request to be generated and the one or more characteristics determined at the present time point results in an imminent BTM steering request, the computing device may output the new steering decision.

In an example, a series of cross-checks of SNR data of the second communication channel in the second band may be performed (e.g., at each time point of the series of time points) before the computing device causes the user device to connect to the network via the second communication channel in the second band. For example, based on the one or more characteristics at the one or more time points satisfying the third threshold, the computing device may determine that SNR data of the second communication channel in the second band at each time point of the series of time points satisfies a second condition. The computing device may cause the user device to connect to the network via the second communication channel in the second band based on the SNR data of the second communication channel in the second band at each time point satisfying the second condition. The second condition may comprise one or more of a value of the SNR data of the second communication channel exceeds a second threshold, or the SNR data of the second communication channel corresponds to a data rate of the second communication channel is greater than a data rate of the first communication channel.

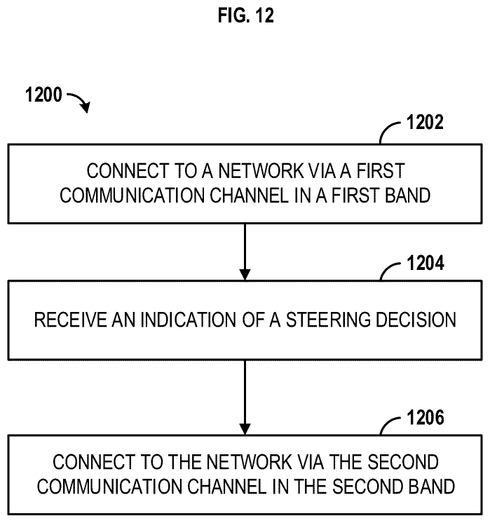

FIG. 12 shows a flow chart of an example method 1200 for performing post-association band steering of a device. For example, an access point, or gateway device, may be configured to provide a plurality of communication channels in different bands (e.g., 2.4 GHz, 5 GHZ, 6 GHZ, etc.) for which devices may access in order to connect to a network. The access point, or gateway device, may provide an up steer or a down steer request to the device for the device to switch from a first communication channel in a first band to a second communication channel in a second band. Method 1200 may be implemented by a user device (e.g., device 102, wearable device, smartphone, mobile device, etc.). At step 1202, a user device (e.g., device 102, wearable device, smartphone, mobile device, etc.) may connect to a network via a first communication channel in a first band. For example, the user device may connect to the network via a first communication channel of a wireless access point, or a gateway device. As an example, a Service Set Identifier (SSID) may be assigned to each band, wherein the user device may connect to the network via the SSID. For example, the first band may be assigned a first SSID and a second band may be assigned a second SSID. The user device may connect to the first communication channel in the first band via the first SSID and connect to a second communication channel in the second band via the second SSID. Each band and corresponding SSID may correspond to a wireless local area network. For example, the first band and corresponding first SSID may be associated with a first wireless local area network and the second band and corresponding second SSID may be associated with a second wireless local area network. The network may comprise the Internet.

At step 1204, an indication of a steering decision may be received based on one or more characteristics of the first communication channel at one or more time points of a series of time points satisfying a threshold. For example, the user device (e.g., device 102, wearable device, smartphone, mobile device, etc.) may receive the indication of the steering decision from the wireless access point based on the one or more characteristics of the first communication channel at the one or more time points of the series of time points satisfying the threshold. The steering decision may comprise one of a steering request or a dis-association action. The one or more characteristics may comprise one or more of a SNR delta, a value associated with the SNR delta, a value associated with a previous SNR delta, or a value associated with a changing rate of SNR delta. The one or more characteristics may be determined based on a series of values of signal-to-noise ratio (SNR) data of the first communication channel according to the series of time points. The one or more characteristics may be determined based on the SNR data of the first communication channel satisfying a condition. For example, a computing device may be triggered to determine the one or more characteristics based on the SNR data of the first communication channel satisfying the condition. The condition may comprise one of a value of the SNR data falling below a first threshold, or a value of the SNR data rising above a second threshold. For example, a value of the SNR data of the first communication channel may fall below a low watermark SNR threshold, or a value of the SNR data may rises above a high watermark SNR threshold. For example, as the user device moves away from a wireless access point, or gateway device, a value of the SNR data of the first communication channel may fall below the first threshold (e.g., low watermark SNR threshold) and the wireless access point may determine that the user device may need to down-steer to the second communication channel in the second band (e.g., the user device should “down steer” from the 5G band to the 2G band). For example, as the user device moves towards the wireless access point, a value of the SNR data may rise above the second threshold (e.g., high watermark SNR threshold) and the wireless access point may determine that the user device may need to up-steer to the second communication channel (e.g., the device should “up steer” from the 2G band to the 5G band).

At step 1206, the user device may connect to the network via the second communication channel in the second band based on the indication. For example, the user device may connect to the network via the second communication channel in the second band of the wireless access point, or gateway device, based on the indication. In an example, if the steering decision comprises the dis-association action, the dis-association action may cause the user device to disconnect from the network via the first communication channel in the first band, wherein the user device may connect to the network via the second communication channel in the second band based on being disconnected from the network via the first communication channel in the first band.

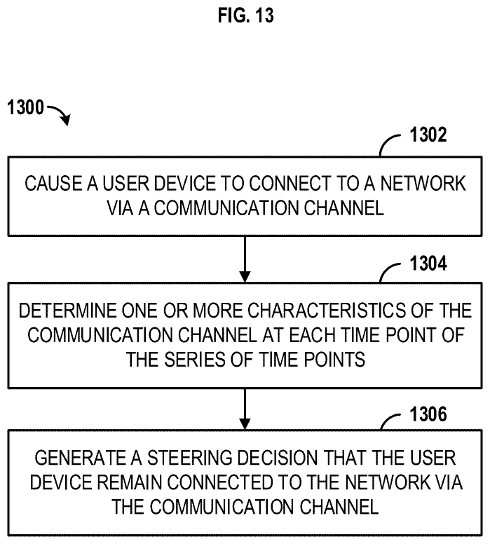

FIG. 13 shows a flow chart of an example method 1300 for performing post-association band steering of a device. For example, an access point, or gateway device, may be configured to provide a plurality of communication channels in different bands (e.g., 2.4 GHz, 5 GHZ, 6 GHZ, etc.) for which devices may access in order to connect to a network. The access point, or gateway device, may provide an up steer or a down steer request to the device for the device to switch from a first communication channel in a first band to a second communication channel in a second band. Method 1300 may be implemented by a computing device (e.g., network device 116, computing device 104, access point, gateway device, etc.). At step 1302, a user device may connect to a network via a communication channel. For example, the computing device (e.g., network device 116, computing device 104, etc.) may cause the user device to connect to the network via a communication channel of the computing device. As an example, a Service Set Identifier (SSID) may be assigned to each band of a network device such as the computing device, wherein the user device may connect to the network via the SSID. For example, a first band may be assigned a first SSID and a second band may be assigned a second SSID. The user device may connect to a communication channel in the first band via the first SSID and connect to a communication channel in the second band via the second SSID. Each band and corresponding SSID may correspond to a wireless local area network. For example, the first band and corresponding first SSID may be associated with a first wireless local area network and the second band and corresponding second SSID may be associated with a second wireless local area network. The network may comprise the Internet.

At step 1304, based on signal-to-noise ratio (SNR) data of the communication channel satisfying a condition, one or more characteristics of the communication channel may be determined at each time point of a series of time points based on a series of values of the SNR data according to the series of time points. For example, based on the SNR data of the communication channel satisfying a condition, the computing device (e.g., network device 116, computing device 104, etc.) may determine the one or more characteristics of the communication channel at each time point of the series of time points based on the series of values of the SNR data according to the series of time points. For example, based on the SNR data crossing a threshold (e.g., condition), the computing device may be triggered to implement a series of cross checks of the SNR data of the communication channel. The computing device may determine one or more characteristics of the communication channel at each time point after the trigger. The one or more characteristics may comprise one or more of a SNR delta, a value associated with the SNR delta, a value associated with a previous SNR delta, or a value associated with a changing rate of SNR delta. The condition may comprise one of a value of the SNR data falling below a first threshold, or a value of the SNR data rising above a second threshold. For example, a value of the SNR data of the communication channel may fall below a low watermark SNR threshold, or a value of the SNR data may rises above a high watermark SNR threshold. For example, as the user device moves away from the computing device, a value of the SNR data of the first communication channel may fall below the first threshold (e.g., low watermark SNR threshold) and the computing device may determine that the user device may need to down-steer to a communication channel in the second band (e.g., the user device should “down steer” from the 5G band to the 2G band). For example, as the user device moves towards the computing device, a value of the SNR data may rise above the second threshold (e.g., high watermark SNR threshold) and the computing device may determine that the user device may need to up-steer to the communication channel in the second band (e.g., the device should “up steer” from the 2G band to the 5G band).

At step 1306, a steering decision that the user device remain connected to the network via the communication channel may be generated based on the one or more characteristics at each time point of the series of time points not satisfying a third threshold. For example, the computing device (e.g., network device 116, computing device 104, etc.) may generate the steering decision that the user device remain connected to the network via the communication channel based on the one or more characteristics at each time point of the series of time points not satisfying the third threshold.

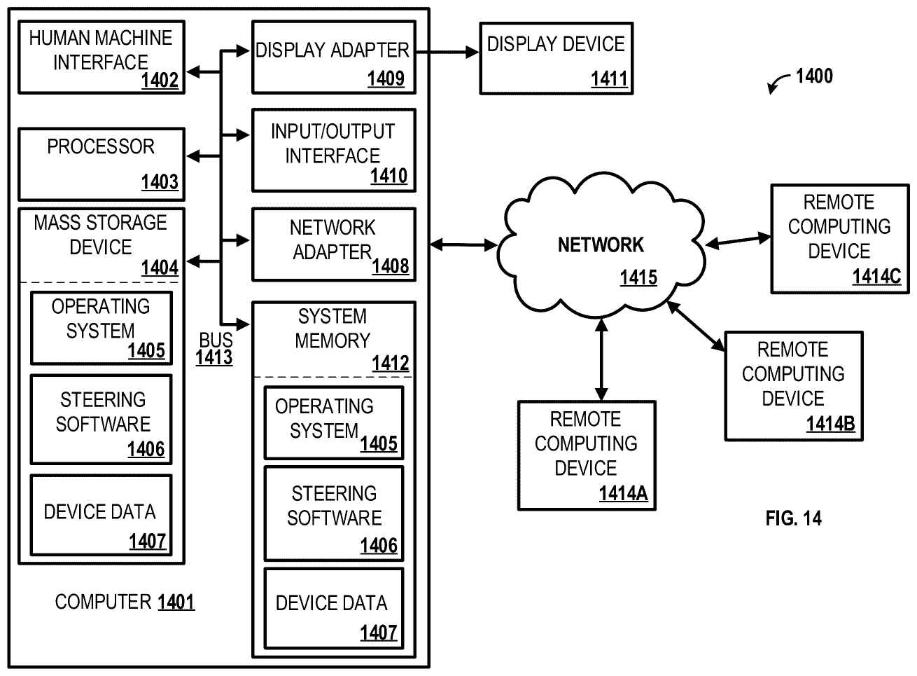

The methods and systems may be implemented on a computer 1401 as shown in FIG. 14 and described below. By way of example, computing device 104, device 102, and/or the network device 116 of FIG. 1 can be a computer 1401 as illustrated in FIG. 14. Similarly, the methods and systems disclosed can utilize one or more computers to perform one or more functions in one or more locations. FIG. 14 shows a block diagram of an example operating environment 1400 for performing the disclosed methods. The operating environment 1400 is an example of an operating environment and is not intended to suggest any limitation as to the scope of use or functionality of operating environment architecture. Neither should the operating environment 1400 be interpreted as having any dependency or requirement relating to any one or combination of components in the operating environment 900.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1401. The computer 1401 can comprise one or more components, such as one or more processors 1403, a system memory 1412, and a bus 1413 that couples various components of the computer 1401 comprising the one or more processors 1403 to the system memory 1412. The system can utilize parallel computing.

The bus 1413 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1413, and all buses specified in this description can also be implemented over a wired or wireless network connection and one or more of the components of the computer 1401, such as the one or more processors 1403, a mass storage device 1404, an operating system 1405, steering software 1406, device data 1407, a network adapter 1408, the system memory 1412, an Input/Output Interface 1410, a display adapter 1409, a display device 1411, and a human machine interface 1402, can be contained within one or more remote computing devices 1414A-1414C at physically separate locations, connected through buses of this form, in effect implementing a fully distributed system.

The computer 1401 may comprise a variety of computer readable media. For example, readable media can be any available media that is accessible by the computer 1401 and comprises, for example and not meant to be limiting, both volatile and non-volatile media, removable and non-removable media. The system memory 1412 can comprise computer readable media in the form of volatile memory, such as random access memory (RAM), and/or non-volatile memory, such as read only memory (ROM). The system memory 1412 typically can comprise data such as the device data 1407 and/or program modules such as the operating system 1405 and the steering software 1406 that are accessible to and/or are operated on by the one or more processors 1403.

The computer 1401 may comprise other removable/non-removable, volatile/non-volatile computer storage media. The mass storage device 1404 can provide non-volatile storage of computer code, computer readable instructions, data structures, program modules, and other data for the computer 1401. For example, the mass storage device 1404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1404, such as, by way of example, the operating system 1405 and the steering software 1406. One or more of the operating system 1405 and the steering software 1406 (or some combination thereof) can comprise elements of the programming and the steering software 1406. The device data 1407 can also be stored on the mass storage device 1404. The device data 1407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1415.

The user can enter commands and information into the computer 1401 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1403 via the human machine interface 1402 that is coupled to the bus 1413, but can be connected by other interface and bus structures, such as a parallel port, game port, an IEEE 1394 Port (also known as a Firewire port), a serial port, a network adapter 1408, and/or a universal serial bus (USB).

The display device 1411 may also be connected to the bus 1413 via an interface, such as the display adapter 1409. It is contemplated that the computer 1401 can have more than one display adapter 1409 and the computer 1401 can have more than one display device 1411. For example, the display device 1411 can be a monitor, an LCD (Liquid Crystal Display), light emitting diode (LED) display, television, smart lens, smart glass, and/or a projector. In addition to the display device 1411, other output peripheral devices can comprise components such as speakers (not shown) and a printer (not shown) which can be connected to the computer 1401 via an Input/Output Interface 1410. Any step and/or result of the methods can be output in any form to an output device. Such output can be any form of visual representation, comprising, but not limited to, textual, graphical, animation, audio, tactile, and the like. The display device 1411 and the computer 1401 can be part of one device, or separate devices.

The computer 1401 can operate in a networked environment using logical connections to one or more remote computing devices 1414A-1414C. By way of example, a remote computing device 1414A-1414C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1401 and a remote computing device 1414A-1414C can be made via a network 1415, such as a local area network (LAN) and/or a general wide area network (WAN). Such network connections can be through the network adapter 1408. The network adapter 1408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1405 are illustrated herein as discrete blocks, although it is recognized that such programs and components can reside at various times in different storage components of the computing device 1401, and are executed by the one or more processors 1403 of the computer 1401. An implementation of the steering software 1406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” may comprise volatile and non-volatile, removable and non-removable media implemented in any methods or technology for storage of information such as computer readable instructions, data structures, program modules, or other data. For example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
causing, by a computing device, a user device to connect to a network via a first communication channel in a first band;
based on signal-to-noise ratio (SNR) data of the first communication channel satisfying a condition, determining, based on a series of values of the SNR data according to a series of time points, one or more characteristics of the first communication channel at each time point of the series of time points; and
based on the one or more characteristics at one or more time points of the series of time points satisfying a threshold, causing the user device to connect to the network via a second communication channel in a second band.

2. The method of claim 1, wherein the first band is associated with a first SSID for a first wireless local area network and the second band is associated with a second SSID for a second wireless local area network, wherein the network comprises the Internet.

3. The method of claim 1, wherein causing the user device to connect to the network via the first communication channel in the first band comprises causing the user device to connect to the network via a first SSID, and wherein causing the user device to connect to the network via the second communication channel in the second band comprises causing the user device to connect to the network via a second SSID.

4. The method of claim 1, wherein the one or more characteristics comprise one or more of a SNR delta, a value associated with the SNR delta, a value associated with a previous SNR delta, or a value associated with a changing rate of SNR delta.

5. The method of claim 1, wherein the condition comprises one of a value of the SNR data falling below a second threshold, or a value of the SNR data rising above a third threshold.

6. The method of claim 1, wherein, based on the one or more characteristics at one or more time points satisfying the threshold, causing the user device to connect to the network via the second communication channel in the second band comprises:
based on the one or more characteristics at the one or more time points satisfying the threshold, determining SNR data of the second communication channel in the second band at each time point satisfies a second condition; and
based on the SNR data of the second communication channel in the second band satisfying the second condition, causing the user device to connect to the network via the second communication channel in the second band.

7. The method of claim 6, wherein the second condition comprises one or more of a value of the SNR data of the second communication channel exceeds a second threshold, or the SNR data of the second communication channel corresponds to a data rate of the second communication channel that is greater than a data rate of the first communication channel.

8. The method of claim 1, wherein causing the user device to connect to the network via the second communication channel in the second band comprises one of:
sending a steering request to the user device, wherein the user device connects to the network via the second communication channel in the second band based on the steering request; or
causing the user device to disconnect from the network via the first communication channel in the first band, wherein the user device connects to the network via the second communication channel in the second band based on being disconnected from the network via the first communication channel in the first band.

9. A method comprising:
connecting, by a user device, to a network via a first communication channel in a first band;
receiving, based on one or more characteristics of the first communication channel at one or more time points of a series of time points satisfying a threshold, an indication of a steering decision, wherein the one or more characteristics are determined based on a series of values of signal-to-noise ratio (SNR) data of the first communication channel according to the series of time points; and
connecting, based on the indication, to the network via a second communication channel in a second band.

10. The method of claim 9, wherein the first band is associated with a first SSID for a first wireless local area network and the second band is associated with a second SSID for a second wireless local area network, wherein the network comprises the Internet.

11. The method of claim 9, wherein causing the connection to the network via the first communication channel in the first band comprises causing the connection to the network via a first SSID, and wherein causing the connection to the network via the second communication channel in the second band comprises causing the connection to the network via a second SSID.

12. The method of claim 9, wherein the one or more characteristics are determined based on SNR data the first communication channel satisfying a condition.

13. The method of claim 12, wherein the condition comprises one of a value of the SNR data falling below a first threshold or a value of the SNR data rising above a second threshold.

14. The method of claim 9, wherein the one or more characteristics comprises one or more of a SNR delta, a value associated with the SNR delta, a value associated with a previous SNR delta, or a value associated with a changing rate of SNR delta.

15. The method of claim 9, wherein the indication comprises a steering request or a dis-association action.

16. The method of claim 15, wherein the dis-association action causes the user device to disconnect from the network via the first communication channel in the first band, wherein the user device connects to the network via the second communication channel in the second band based on being disconnected from the network via the first communication channel in the first band.

17. A method comprising:
causing, by a computing device, a user device to connect to a network via a communication channel;
based on signal-to-noise ratio (SNR) data of the communication channel satisfying a condition, determining, based on a series of values of the SNR data according to a series of time points, one or more characteristics of the communication channel at each time point of the series of time points; and
based on the one or more characteristics at each time point not satisfying a threshold, generating a steering decision that the user device remain connected to the network via the communication channel.

18. The method of claim 17, wherein the communication channel is associated with a SSID, wherein the network comprises the Internet.

19. The method of claim 17, wherein the one or more characteristics comprises one or more of a SNR delta, a value associated with the SNR delta, a value associated with a previous SNR delta, or a value associated with a changing rate of SNR delta.

20. The method of claim 17, wherein the condition comprises one of a value of the SNR data falling below a second threshold or a value of the SNR data rising above a third threshold.
